(19) United States
(12) Patent Application Publication
(10) Pub. No.: US 2026/0296919 A1
(43) Pub. Date: Oct. 1, 2026

(54) POSITIVE ELECTRODE ACTIVE MATERIAL AND BATTERY

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/560,320

(22) Filed: Mar. 9, 2026

(30) Foreign Application Priority Data
Mar. 25, 2025 (JP) 2025-049938

(51) Int. Cl. C01G 53/506; H01M 4/02; H01M 4/36; H01M 4/525; H01M 10/0525

(52) U.S. Cl. CPC C01G 53/506; H01M 4/366; H01M 4/525; C01P 2004/84; C01P 2006/40; H01M 2004/021; H01M 2004/028; H01M 10/0525

(57) ABSTRACT

The present disclosure provides a positive electrode active material, in which the positive electrode active material has crystalline primary particles containing Li, TM (TM is a transition metal), and O, the positive electrode active material is a single crystal active material made of the primary particles, a compound A containing La, Ni, and O and a compound B containing Li, W, and O are present on a surface of the primary particles, the compound A has a particle shape, the compound B has a film shape, and the compound B covers the surface of the primary particles and covers a surface of the compound A, thereby solving the above-described problem.

### CROSS-REFERENCE TO RELATED APPLICATION

This application claims priority to Japanese Patent Application No. 2025-049938 filed on Mar. 25, 2025. The disclosure of the above-identified application, including the specification, drawings, and claims, is incorporated by reference herein in its entirety.

### BACKGROUND

### 1. Technical Field

The present disclosure relates to a positive electrode active material and a battery.

### 2. Description of Related Art

In recent years, the development of a battery has been actively performed. For example, in the automotive industry, development of a battery used in a battery electric vehicle (BEV), a plug-in hybrid electric vehicle (PHEV), or a hybrid electric vehicle (HEV) is being carried out. As a positive electrode active material used in a battery, an active material containing a transition metal such as Ni, Co, and Mn is known.

For example, Japanese Unexamined Patent Application Publication (Translation of PCT Application) No. 2022-542774 (JP 2022-542774 A) discloses a W-containing high-nickel ternary positive electrode material having a chemical formula of LiₐNiₓCo_{y}Mn_{1-x-y}W_{b}M_{c}O₂. The high-nickel ternary positive electrode material contains both spherical secondary particles and single crystal particles. A W-containing high-nickel ternary positive electrode material is disclosed, in which the single crystal particles basically do not contain a W element, and the W element is doped into the spherical secondary particles.

Japanese Unexamined Patent Application Publication (Translation of PCT Application) No. 2024-511223 (JP 2024-511223 A) discloses a single crystal type multi-element positive electrode material. A ratio of a length of the longest diagonal line to a length of the shortest diagonal line of single crystal particles of the single crystal type multi-element positive electrode material, which is measured by SEM, is defined as a circularity R, and R is 1 or more. A single crystal type multi-element positive electrode material is disclosed, in which D₁₀, D₅₀, and D₉₀ of single crystal particles of the single crystal type multi-element positive electrode material satisfy K₉₀=(D₉₀−D₁₀)/D₅₀, and a product of K₉₀ and R is 1.20 to 1.40.

Hujun Zhang et al., “Perovskite-coated small-size single-crystalline W-doped Ni-rich cathodes with greatly enhanced power density for Li-ion batteries”, Journal of Materials Chemistry A, Issue 36, 2024 discloses that LiNi_{0.85}Co_{0.05}Mn_{0.10}O₂ is W-doped and further coated with perovskite La₄NiLiO₈.

### SUMMARY

From the viewpoint of improving battery performance, reducing resistance and reducing the cycle resistance increase rate are desired. The present disclosure has been made in view of the above circumstances, and a main object of the present disclosure is to provide a positive electrode active material capable of reducing resistance and reducing a cycle resistance increase rate.
[1] A positive electrode active material including primary particles that have crystallinity, the primary particles containing Li, a transition metal (TM), and O, in which the positive electrode active material is a single crystal active material made of the primary particles,
a compound A containing La, Ni, and O and a compound B containing Li, W, and O are present on a surface of the primary particles,
the compound A has a particle shape,
the compound B has a film shape, and
the compound B covers the surface of the primary particles and covers a surface of the compound A.
[2] The positive electrode active material according to [1], in which, in a cross section of the positive electrode active material, a proportion of the compound B that covers the surface of the compound A is 10% or more.
[3] The positive electrode active material according to [1] or [2], in which, in a cross section of the positive electrode active material, a thickness of the compound B that covers the surface of the compound A is 20 nm or less.
[4] The positive electrode active material according to any one of [1] to [3], in which in a case where a W intensity is measured by EELS analysis from a surface of the compound B that covers the compound A toward a center of the primary particles, first, a peak having a peak intensity α is detected, next, a constant intensity β is detected, and then, a constant intensity γ is detected, and
the peak intensity α, the constant intensity β, and the constant intensity γ satisfy a relationship of α>γ>β.
[5] A battery including a positive electrode active material layer containing a positive electrode active material, a negative electrode active material layer containing a negative electrode active material, and an electrolyte layer disposed between the positive electrode active material layer and the negative electrode active material layer, in which the positive electrode active material layer contains the positive electrode active material according to any one of [1] to [4].

The present disclosure has an effect of providing a positive electrode active material capable of reducing resistance and reducing a cycle resistance increase rate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a positive electrode active material according to the present disclosure;

FIG. 2 is a schematic cross-sectional view illustrating the positive electrode active material according to the present disclosure;

FIG. 3 is a schematic cross-sectional view illustrating a battery according to the present disclosure; and

FIG. 4 is a flowchart illustrating a method of manufacturing the positive electrode active material in the present disclosure.

### DETAILED DESCRIPTION OF EMBODIMENTS

Hereinafter, an embodiment will be described with reference to the drawings. However, the present disclosure can be implemented in many different aspects, and is not limited to the description of the embodiments described below. In addition, the drawings may schematically show each part in terms of width, thickness, and shape in order to make the description more clear, as compared with the actual form, but this is merely an example and is not limited.

### A. Positive Electrode Active Material

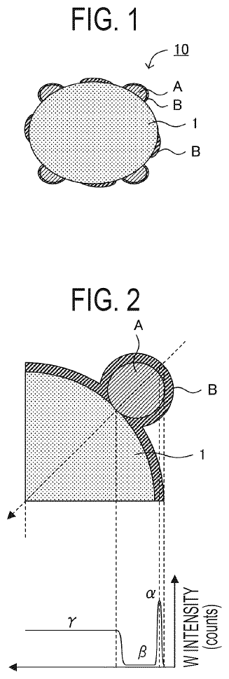

FIG. 1 is a schematic cross-sectional view illustrating a positive electrode active material according to the present disclosure. As shown in FIG. 1, a positive electrode active material 10 has crystalline primary particles 1 containing Li, TM (TM is a transition metal), and O. In addition, the positive electrode active material 10 is a single crystal active material made of the primary particles 1. A compound A containing La, Ni, and O and a compound B containing Li, W, and O are present on a surface of the primary particles 1. The compound A has a particle shape, and the compound B has a film shape. In addition, the compound B covers the surface of the primary particles 1 and covers a surface of the compound A.

According to the present disclosure, since the compound A having favorable electron conductivity (compound containing La, Ni, and O) is present on the surface of the primary particles, it is possible to reduce resistance. In addition, in the present disclosure, since the compound B having favorable ion conductivity (compound containing Li, W, and O) is present on the surface of the primary particles, it is possible to reduce resistance.

In addition, it is presumed that, since the compound A has favorable electron conductivity, it is possible to reduce resistance, but a resistance component (decomposition product) is accumulated due to a side reaction caused by electron conductivity, and the resistance increases over time. On the other hand, it is presumed that, since the compound B has moderately low electron conductivity, it is possible to suppress the accumulation of the resistance component (decomposition product) in the positive electrode active material and to suppress the increase in resistance over time. In the present disclosure, the compound B covers the surface of the primary particles and covers a surface of the compound A. Therefore, it is possible to suppress the accumulation of the resistance component (decomposition product) generated by the side reaction caused by electron conductivity on the surface of the compound A, and to reduce the cycle resistance increase rate.

In addition, for example, a mixture containing a transition metal hydroxide as a precursor, a La source, and a W source is calcined, thereby providing the compound A and the compound B. In this case, it is possible to provide the compound A and the compound B on the surface of the primary particles, respectively, but it is difficult to provide the compound B so as to cover the compound A. On the other hand, in the present disclosure, as will be described later, a first calcination step of calcining a first mixture containing a transition metal hydroxide and a La source is performed to provide the compound A on the surface of the primary particles. Thereafter, by performing a second calcination step of adding a W source and further calcining, the compound B can be provided so as to cover the compound A. In order to obtain the compound B by reaction of the W source with Li, it is preferable that a Li source is also added at the same time in the second calcination step. In addition, in order to promote the reaction that provides the compound B from the W source and the Li source, it is preferable to use an oxidizing agent.

### 1. Primary Particle

The primary particles in the present disclosure are crystalline particles containing Li, TM (TM is a transition metal), and O. Examples of the crystal structure of the primary particles include a layered rock salt type and a spinel type, and the layered rock salt type is preferable. In addition, the primary particles may have a crystal structure belonging to a space group R-3m.

The primary particles contain Li, TM (TM is a transition metal), and O. The primary particles may contain one kind of transition metal, may contain two kinds of transition metals, may contain three kinds of transition metals, or may contain four or more kinds of transition metals.

The transition metal is a metal belonging to Group 3 to Group 11 in the periodic table. The transition metal contained in the primary particles may be a metal belonging to the third period, the fourth period, or the fifth period. Examples of the transition metal include Ti, V, Cr, Mn, Fe, Co, Ni, Zr, Nb, La, and W.

It is preferable that the primary particles contain at least Ni. This is because a positive electrode active material having favorable capacity characteristics can be obtained. In a case where all the transition metals (TM) contained in the primary particles are set to 1 part by mole, a proportion of Ni contained in the primary particles is, for example, 0.25 parts by mole or more, and may be 0.33 parts by mole or more. The proportion of Ni may be 0.50 parts by mole or more, may be 0.75 parts by mole or more, may be 0.80 parts by mole or more, or may be 0.90 parts by mole or more. By increasing the proportion of Ni, the capacity characteristics are improved.

The primary particles may contain Co or may not contain Co. In a case where all the transition metals (TM) contained in the primary particles are defined as 1 part by mole, a proportion of Co contained in the primary particles is, for example, 0 parts by mole or more, and may be 0.05 parts by mole or more or 0.10 parts by mole or more. On the other hand, the proportion of Co contained in the primary particles is, for example, 0.40 parts by mole or less, and may be 0.20 parts by mole or less.

The primary particles may contain Mn or may not contain Mn. In a case where all the transition metals (TM) contained in the primary particles are defined as 1 part by mole, a proportion of Mn contained in the primary particles is, for example, 0 parts by mole or more, and may be 0.05 parts by mole or more or 0.10 parts by mole or more. On the other hand, the proportion of Mn contained in the primary particles is, for example, 0.40 parts by mole or less, and may be 0.20 parts by mole or less.

It is preferable that the primary particles contain at least one of Ni, Co, and Mn. In a case where all the metals (excluding Li) contained in the primary particles are set to 1 part by mole, a total proportion of Ni, Co, and Mn contained in the primary particles is, for example, 0.80 parts by mole or more. The total proportion of Ni, Co, and Mn may be 0.90 parts by mole or more, or may be 0.95 parts by mole or more. It is noted that the “total of Ni, Co, and Mn” also includes a case where the proportion of one or two of Ni, Co, and Mn is 0.

The primary particles may contain a metal M¹ (including a metalloid) other than Li and TM in addition to Li and TM. Examples of the other metal M¹ include a metal belonging to Group 12 to Group 14 in the periodic table. Examples of the metal belonging to Group 12 to Group 14 include Zn, Al, Si, Ga, Ge, In, and Sn.

A composition of the primary particles is not particularly limited, but may be, for example, a composition represented by a general formula LiₓNiₐCo_{b}Mn_{c}O_{y} (0.1≤x≤1.5, 0.5≤a≤1.0, 0≤b≤0.3, 0≤c≤0.3, 0.001≤d≤0.1, 0.001≤e≤0.1, a+b+c+d+e=1.0, 1.5≤y≤2.1).

The positive electrode active material in the present disclosure is usually a single crystal active material made of the primary particles. The single crystal active material means that the active material is not a so-called polycrystalline active material (active material in which a large number of primary particles are aggregated without a gap). The single crystal active material is usually not aggregated and exists as one independent particle. In the single crystal active material, grain boundaries are preferably not observed in a scanning electron microscope (SEM) observation (magnification: about 10,000 to 30,000 times). The single crystal active material has an advantage of less deterioration over time as compared with the polycrystalline active material.

A particle diameter of the primary particles is, for example, 0.5 μm or more, and may be 0.6 μm or more, 0.8 μm or more, or 1.0 μm or more. In a case where the particle diameter of the primary particles is too small, the particles may not sufficiently grow, and it may be difficult to prepare the single crystal. On the other hand, the particle diameter of the primary particles is, for example, 20 μm or less, and may be 15 μm or less, 10 μm or less, or 5 μm or less. The particle diameter of the primary particles is obtained as, for example, the longest diameter in the SEM observation. In addition, for example, in a case where the positive electrode active material layer contains the primary particles (positive electrode active material), the particle diameter (longest diameter) of the primary particles may be obtained from a cross-sectional image of the positive electrode active material layer.

### 2. Compound A

The compound A in the present disclosure contains La, Ni, and O. Since the compound A usually has high electron conductivity, the compound A is present on the surface of the primary particles, whereby the resistance can be reduced. The compound A may be directly disposed on the surface of the primary particles or may be disposed through another layer (another compound), but the former is preferable.

The compound A contains at least La, Ni, and O. The compound A may be made of only La, Ni, and O, or may further contain other elements. Examples of the other elements include Li. That is, the compound A may contain Li or may not contain Li. Examples of the composition of the compound A include LaₐNi_{b}O_{c} (0.8≤a≤1.2, 0.8≤b≤1.2, 2.8≤c≤3.2). For example, LaNiO₃ has a typical perovskite composition and favorable electron conductivity. Examples of the composition of the compound A include LaₐLi_{b}Ni_{c}O_{d} (3.5≤a≤4.5, 0.5≤b≤1.5, 0.5≤c≤1.5, 7.5≤d≤8.5). For example, it is known that La₄LiNiO₈ has favorable electron conductivity, and it is assumed to have a crystal phase similar to perovskite.

The compound A may be crystalline or may be amorphous, but the former is preferable. This is because favorable electron conductivity can be obtained. The “compound is crystalline” means that a peak derived from the compound to be examined is confirmed by X-ray diffraction using a CuKα ray. On the other hand, the “compound is amorphous” means that a peak derived from the compound to be symmetrical is not confirmed by X-ray diffraction using a CuKα ray. It is noted that, in a case where the target compound is amorphous, a halo pattern may be observed instead of the peak.

The compound A preferably has a perovskite crystal phase or a crystal phase similar to perovskite. It is preferable that the compound A has at least one crystal phase of LaNiO₃ or La₄LiNiO₈. This is because favorable electron conductivity can be obtained. It is noted that the crystal phase includes a crystal phase in which a part of the constituent atoms (for example, a part of O atoms) is deficient and a crystal phase in which a part of the constituent atoms (for example, a part of La atoms) is in surplus.

The compound A usually has a particle shape. The “compound A has a particle shape” means that, in a case where a length of the compound A in a normal direction of the surface of the primary particles is defined as L₁ and a length of the compound A in a direction perpendicular to the normal direction is defined as L₂ in a cross-sectional image of the primary particles, a ratio (L₂/L₁) of L₂ to Li is 3.0 or less. The cross-sectional image of the primary particles is, for example, an SEM cross-sectional image.

In a case where all the transition metals contained in the primary particles are set to 1 part by mole, a proportion of La contained in the compound A is, for example, 0.001 parts by mole or more, and may be 0.003 parts by mole or more, or 0.005 parts by mole or more. On the other hand, the above-described proportion of La contained in the compound A is, for example, 0.100 parts by mole or less, and may be 0.080 parts by mole or less, or 0.060 parts by mole or less.

A coating rate of the compound A on the primary particles is not particularly limited, but is, for example, 10% or more and 90% or less, and may be 20% or more and 80% or less, or 30% or more and 70% or less. The coating rate of the compound A can be determined from, for example, an analysis of a top surface by X-ray photoelectron spectroscopy (XPS). For example, in a case where the primary particles contain Ni, Co, and Mn as the transition metal TM, the La amount and each TM amount (Ni amount, Co amount, and Mn amount) can be determined by the analysis of the top surface by XPS, and La/(La+TM) can be used as the coating rate. The coating rates of the compounds A, B can also be determined in the same manner. In addition, the electron conductivity of the compound A is usually higher than the electron conductivity of La₂O₃. The electron conductivity of the compound A at 25° C. is, for example, 5.0×10⁻⁴ S/cm or more, and may be 1.0×10⁻³ S/cm or more. In addition, the compound A (compound containing La, Ni, and O) is disposed on the surface of the primary particles. The primary particles may contain La or may not contain La.

### 3. Compound B

The positive electrode active material in the present disclosure may have a compound B containing Li, W, and O on the surface of the primary particles. Since the compound B usually has high ion conductivity, the compound B is present on the surface of the primary particles, whereby the resistance can be reduced. In addition, since the compound B is present on the surface of the primary particles, an increase in resistance over time can be suppressed. The compound B may be directly disposed on the surface of the primary particles or may be disposed through another layer (another compound), but the former is preferable.

The compound B contains at least Li, W, and O. The compound B may be made of only Li, W, and O, or may further contain other elements. Examples of the composition of the compound B include LiₐW_{b}O_{c} (5.5≤a≤6.5, 0.5≤b≤1.5, 5.5≤c≤6.5). The compound B having the above-described composition is typically Li₆WO₆. Examples of the composition of the compound B include LiₐW_{b}O_{c} (1.5≤a≤2.5, 0.5≤b≤1.5, 3.5≤c≤4.5). The compound B having the above-described composition is typically Li₂WO₄. In addition, examples of the composition of the compound B include LiₐW_{b}O_{c} (3.5≤a≤4.5, 0.5≤b≤1.5, 4.5≤c≤5.5). The compound B having the above-described composition is typically Li₄WO₅. In addition, examples of the composition of the compound B include LiₐW_{b}O_{c} (1.5≤a≤2.5, 1.5≤b≤2.5, 6.5≤c≤7.5). The compound B having the above-described composition is typically Li₂W₂O₇.

The compound B may be crystalline or may be amorphous. In addition, the compound B is usually in a film shape. The “compound B is in a film shape” means that, in a case where a length of the compound B in a normal direction of the surface of the primary particles is defined as L₃ and a length of the compound B in a direction perpendicular to the normal direction is defined as L₄ in a cross-sectional image of the primary particles, a ratio (L₄/L₃) of L₄ to L₃ is greater than 3.0. The cross-sectional image of the primary particles is, for example, a transmission electron microscope (TEM) cross-sectional image. A thickness (length L₃) of the compound B is not particularly limited, but is, for example, 0.5 nm or more and 20 nm or less, and may be 1 nm or more and 15 nm or less. The thickness of the compound B is obtained as an average value measured at least at five locations in the observation by TEM.

In a case where all the transition metals contained in the primary particles are set to 1 part by mole, a proportion of W contained in the compound B is, for example, 0.001 parts by mole or more, and may be 0.003 parts by mole or more, or 0.005 parts by mole or more. On the other hand, the above-described proportion of W contained in the compound B is, for example, 0.100 parts by mole or less, and may be 0.080 parts by mole or less, or 0.060 parts by mole or less.

A coating rate of the compound B on the primary particles is not particularly limited, but is, for example, 10% or more and 90% or less, and may be 20% or more and 80% or less, or 30% or more and 70% or less. In addition, the ion conductivity of the compound B is usually higher than the ion conductivity of W₂O₃. The ion conductivity of the compound B at 25° C. is, for example, 1.0×10⁻⁵ S/cm or more, and may be 1.0×10⁻⁴ S/cm or more. In addition, the compound B (compound containing Li, W, and O) is disposed on the surface of the primary particles. The primary particles may contain W or may not contain W.

### 4. Positive Electrode Active Material

In the positive electrode active material, the compound B covers the surface of the primary particles and covers a surface of the compound A. In a cross section of the positive electrode active material, a proportion (coating rate) of the compound B covering a surface of the compound A is, for example, 10% or more, and may be 30% or more or 50% or more. The coating rate can be obtained by the TEM observation.

In a cross section of the positive electrode active material, a thickness of the compound B covering a surface of the compound A is not particularly limited, but is, for example, 20 nm or less, and may be 15 nm or less. On the other hand, the thickness of the compound B covering a surface of the compound A is, for example, 0.5 nm or more, and may be 1.0 nm or more. The thickness of the compound B covering a surface of the compound A can be obtained by the TEM observation.

As shown in FIG. 2, in a case where a W intensity is measured by electron energy loss spectroscopy (EELS) analysis from a surface of the compound B covering the compound A toward a center of the primary particles 1, first, a peak having a peak intensity α is detected. Next, it is preferable that a constant intensity β is detected, and then a constant intensity γ is detected. The peak corresponds to an intensity of W contained in the compound B covering the compound A. In addition, the constant intensity β corresponds to an intensity of W contained in the compound A, and the constant intensity γ corresponds to an intensity of W contained in the primary particles. As shown in FIG. 2, it is preferable that the peak intensity α, the constant intensity β, and the constant intensity γ satisfy a relationship of α>γ>β.

A method of manufacturing the positive electrode active material is not particularly limited, but examples thereof include a method described in “D. Method of manufacturing positive electrode active material” described later.

In addition, in the present disclosure, there is provided a positive electrode active material powder, in which the positive electrode active material powder contains a plurality of single crystal active materials made of crystalline primary particles containing Li, TM (TM is a transition metal), and O as the positive electrode active material. At least a part of the single crystal active materials is a single crystal active material X. The single crystal active material X has a compound A containing La, Ni, and O and having a particle shape, and a compound B containing Li, W, and O and having a film shape on the surface of the primary particles. The compound B can also provide a positive electrode active material powder in which the compound B covers the surface of the primary particles and covers a surface of the compound A. In addition, a proportion of the single crystal active material X to all the positive electrode active materials in the positive electrode active material powder is, for example, 5% by mass or more. The proportion of the single crystal active material X may be 10% by mass or more, 20% by mass or more, 30% by mass or more, 40% by mass or more, 50% by mass or more, 60% by mass or more, or 70% by mass or more.

### B. Positive Electrode Mixture

In the present disclosure, a positive electrode mixture containing the above-described positive electrode active material can also be provided.

According to the present disclosure, by using the above-described positive electrode active material, a positive electrode mixture capable of reducing resistance and reducing a cycle resistance increase rate is obtained. The positive electrode mixture may contain other materials (for example, a conductive material and a binder) in addition to the positive electrode active material. In addition, the positive electrode mixture may contain the above-described positive electrode active material powder. In addition, the positive electrode mixture may be in a powder form or may be in a slurry form containing a dispersion medium.

A proportion of the positive electrode active material in the solid content of the positive electrode mixture is, for example, 20% by mass or more, and may be 30% by mass or more or 40% by mass or more. In a case where the proportion of the positive electrode active material is too small, there is a possibility that a sufficient energy density cannot be obtained. On the other hand, the proportion of the positive electrode active material in the solid content of the positive electrode mixture is, for example, 95% by mass or less, and may be 70% by mass or less or 60% by mass or less. In a case where the proportion of the positive electrode active material is too large, the ion conductivity and the electron conductivity may be relatively reduced.

The positive electrode mixture may contain a conductive material. By adding the conductive material, the electron conductivity is improved. Examples of the conductive material include a carbon-based conductive material, metal particles, and a conductive polymer. Examples of the carbon-based conductive material include particle-shaped materials such as acetylene black (AB) and ketjen black (KB), and fiber-shaped materials such as vapor-grown carbon fiber (VGCF), carbon nanotube (CNT), and carbon nanofiber (CNF).

The positive electrode mixture may contain a binder. By adding the binder, a positive electrode active material layer in which the positive electrode active material is less likely to fall off is obtained. Examples of the binder include a rubber-based binder such as styrene-butadiene rubber (SBR) and butadiene rubber (BR), a polycarboxylic acid-based binder such as carboxymethyl cellulose, and a fluorinated binder such as polyvinylidene fluoride (PVdF).

### C. Battery

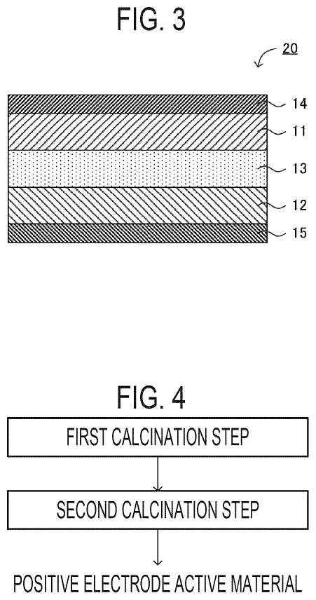

FIG. 3 is a schematic cross-sectional view illustrating the battery according to the present disclosure. A battery 20 shown in FIG. 3 includes a positive electrode active material layer 11, a negative electrode active material layer 12, an electrolyte layer 13 which is disposed between the positive electrode active material layer 11 and the negative electrode active material layer 12, a positive electrode current collector 14 which collects current of the positive electrode active material layer 11, and a negative electrode current collector 15 which collects current of the negative electrode active material layer 12. In the present disclosure, the positive electrode active material layer 11 contains the positive electrode active material described in “A. Positive electrode active material” or the positive electrode mixture described in “B. Positive electrode mixture”.

According to the present disclosure, by using the above-described positive electrode active material or positive electrode mixture, a battery in which the resistance and the cycle resistance increase rate are reduced is obtained.

### 1. Positive Electrode Active Material Layer

The positive electrode active material layer contains at least the positive electrode active material. In addition, the positive electrode active material layer may contain a conductive material and a binder. The positive electrode active material, the conductive material, and the binder are the same as those described in “A. Positive electrode active material” and “B. Positive electrode mixture” described above.

The positive electrode active material layer may contain an electrolyte. The electrolyte is, for example, an electrolytic solution described later. On the other hand, the positive electrode active material layer may contain a solid electrolyte. A thickness of the positive electrode active material layer is, for example, 0.1 μm or more and 1,000 μm or less, and may be 1 μm or more and 500 μm or less, or 30 μm or more and 100 μm or less.

### 2. Negative Electrode Active Material Layer

The negative electrode active material layer contains at least the negative electrode active material. Examples of the negative electrode active material include a carbon-based active material, an Li-based active material, an Si-based active material, and an oxide-based active material.

Examples of the carbon-based active material include graphite, soft carbon, and hard carbon. The graphite may be natural graphite or artificial graphite. Examples of the Li-based active material include Li and a Li alloy. Examples of the Li alloy include a Li—Si alloy. Examples of the Si-based active material include Si, a SiC composite active material, an Si alloy, and an Si oxide. Examples of the SiC composite active material include an active material in which Si or an Si alloy is supported on a carbon carrier. Examples of the oxide-based active material include lithium titanate such as Li₄Ti₅O₁₂.

The negative electrode active material layer may contain at least one of a conductive material, a binder, and an electrolyte. Details of the conductive material, the binder, and the electrolyte are the same as those described in “1. Positive electrode active material layer” described above. In addition, a thickness of the negative electrode active material layer is, for example, 0.1 μm or more and 1,000 μm or less, and may be 1 μm or more and 500 μm or less, or 30 μm or more and 100 μm or less.

### 3. Electrolyte Layer

The electrolyte layer is a layer disposed between the positive electrode active material layer and the negative electrode active material layer, and contains at least an electrolyte. The electrolyte is, for example, a liquid electrolyte (electrolytic solution).

Examples of the electrolytic solution include a non-aqueous electrolytic solution. The non-aqueous electrolytic solution contains, for example, a lithium salt and a non-aqueous solvent. Examples of the lithium salt include inorganic lithium salts such as LiPF₆, LiBF₄, LiClO₄, and LiAsF₆; and organic lithium salts such as LiCF₃SO₃, LiN(SO₂CF₃)₂, LiN(SO₂C₂F₅)₂, and LiC(SO₂CF₃)₃.

Examples of the non-aqueous solvent include carbonate-based solvents such as ethylene carbonate (EC), propylene carbonate (PC), butylene carbonate (BC), dimethyl carbonate (DMC), diethyl carbonate (DEC), and ethyl methyl carbonate (EMC). The non-aqueous electrolytic solution may contain an ionic liquid. In addition, examples of the electrolytic solution include an aqueous electrolytic solution. Further, the electrolyte layer may include a separator impregnated with the above-described electrolytic solution.

### 4. Battery

The battery according to the present disclosure preferably includes a positive electrode current collector which collects current of the positive electrode active material layer and a negative electrode current collector which collects current of the negative electrode active material layer.

A type of the battery according to the present disclosure is not particularly limited, but is typically a lithium-ion battery. In addition, the battery according to the present disclosure may be a primary battery or may be a secondary battery, but the battery is preferably a secondary battery. It is because a secondary battery can be repeatedly charged and discharged and is useful, for example, as an in-vehicle battery. Examples of an application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, it is preferably used as a drive power source of a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

### D. Method of Manufacturing Positive Electrode Active Material

In the present disclosure, a method of manufacturing a positive electrode active material, which manufactures the above-described positive electrode active material, can also be provided. As shown in FIG. 4, the method of manufacturing a positive electrode active material preferably includes a first calcination step of calcining a first mixture containing a transition metal hydroxide containing the above-described TM, a Li source, a Ni source, and a La source at a temperature T₁ to obtain a first calcined product. The method of manufacturing a positive electrode active material preferably includes a second calcination step of adding a W source, a Li source, and an oxidizing agent to the first calcined product to prepare a second mixture, and calcining the second mixture at a temperature T₂ to obtain a second calcined product. The temperature T₂ is preferably lower than the temperature T₁.

According to the present disclosure, by performing the first calcination step and the second calcination step, it is possible to obtain a positive electrode active material capable of reducing resistance and reducing a cycle resistance increase rate.

### 1. First Calcination Step

The first calcination step is a step of calcining a first mixture containing a transition metal hydroxide containing the above-described TM, a Li source, a Ni source, and a La source at a temperature T₁ to obtain a first calcined product.

The transition metal hydroxide contains TM (TM is a transition metal). The transition metal hydroxide corresponds to a precursor of the positive electrode active material. The transition metal hydroxide may contain Ni or may not contain Ni.

A method of synthesizing the transition metal hydroxide is not particularly limited, but examples thereof include the following methods. First, an aqueous solution of a raw material of the transition metal hydroxide is prepared. Examples of a method of preparing the aqueous solution of a raw material include a method of dissolving a water-soluble transition metal compound in water. Examples of the transition metal compound include metal salts such as a sulfate and a nitrate. Examples of the Ni source include NiSO₄ and Ni(NO₃)₂. Examples of the Co source include CoSO₄, Co(NO₃)₂, and Co(NO₃)₃. Examples of the Mn source include MnSO₄ and Mn(NO₃)₂. A composition of the aqueous solution of a raw material is appropriately adjusted according to the positive electrode active material to be obtained.

Next, an aqueous sodium hydroxide solution is added to the reaction container, and the aqueous solution of a raw material and an aqueous ammonia solution are added dropwise while maintaining the pH in an alkaline range (for example, pH 11.3 to 12.0). A reaction temperature is not particularly limited, but is, for example, 50° C. or higher and 65° C. or lower. After the reaction is completed, it is preferable to filter the reaction solution to take out the transition metal hydroxide, and then wash the transition metal hydroxide with water and dry the transition metal hydroxide.

In the first calcination step, a first mixture containing a transition metal hydroxide, a Li source, a Ni source, and a La source is prepared. Examples of the Li source include lithium hydroxide, lithium carbonate, lithium nitrate, lithium acetate, lithium oxide, and lithium chloride. The Li source may be lithium hydroxide or may be a Li-containing compound other than lithium hydroxide. A molar ratio of Li in the Li source to the TM contained in the transition metal hydroxide is, for example, 0.8 or more and 1.2 or less, and may be 0.9 or more and 1.1 or less, or may be 1.0.

Examples of the La source include: hydroxides; and metal salts such as sulfates and nitrates. Examples of the La source include La(OH)₃, LaSO₄, and La(NO₃)₃. In a case where the transition metal hydroxide contains Ni, the transition metal hydroxide may also serve as the Ni source. On the other hand, in a case where the transition metal hydroxide does not contain Ni, it is necessary to use a Ni source separately. Examples of the Ni source include Ni(OH)₂, NiSO₄, and Ni(NO₃)₂. An addition amount of the La source and the Ni source is appropriately adjusted according to the positive electrode active material to be obtained.

The mixture preferably has a molten salt. By functioning as a flux, the molten salt can sufficiently promote grain growth of the primary particles. The molten salt may contain Li. Examples of the molten salt include lithium hydroxide. A molar ratio (Li/TM) of Li contained in the molten salt to the TM contained in the transition metal hydroxide is, for example, 0.1 or more and less than 0.6. Li/TM may be 0.15 or more, 0.2 or more, or 0.25 or more. On the other hand, Li/TM may be 0.55 or less, or may be 0.5 or less.

In the first calcination step, the first mixture is calcined at a temperature T₁ to obtain a first calcined product. The temperature T₁ is, for example, 700° C. or higher and 1100° C. or lower, and may be 800° C. or higher and 1000° C. or lower. In a case where the temperature T₁ is too high, La₂O₃ may be easily generated. On the other hand, in a case where the temperature T₁ is too low, it is difficult to promote sufficient grain growth of the primary particles.

A calcination time in the first calcination step is not particularly limited, but is, for example, 5 hours or longer and 15 hours or shorter, and may be 8 hours or longer and 12 hours or shorter. An atmosphere in the first calcination step is usually an atmosphere in which oxygen is present. Examples of a calcination method in the first calcination step include a method of using a calcining furnace such as a muffle furnace and an electric furnace.

In the first calcination step, a pulverization process of pulverizing the first calcined product may be performed. Examples of a pulverization method in the pulverization process include a jet mill, a hammer mill, a lab mill, and a ball mill.

### 2. Second Calcination Step

The second calcination step is a step of adding a W source, a Li source, and an oxidizing agent to the first calcined product to prepare a second mixture, and calcining the second mixture at a temperature T₂ to obtain a second calcined product.

Examples of the W source include H₂WO₄. An addition amount of the W source is appropriately adjusted according to the positive electrode active material to be obtained. The Li source is as described above. In the second mixture, a molar ratio of Li in the Li source to the TM contained in the transition metal hydroxide is, for example, 0.003 or more and 0.100 or less, and may be 0.005 or more and 0.05 or less. Examples of the oxidizing agent include KMnO₄. In the second mixture, a molar ratio of the oxidizing agent to the TM contained in the transition metal hydroxide is, for example, 0.5 or more and 1.5 or less, and may be 0.75 or more and 1.2 or less.

The temperature T₂ in the second calcination step is preferably lower than the temperature T₁ in the first calcination step. A difference between the temperature T₁ and the temperature T₂ is, for example, 100° C. or more, and may be 200° C. or more. In addition, the temperature T₂ is, for example, 500° C. or higher and 700° C. or lower, and may be 550° C. or higher and 650° C. or lower. In a case where the temperature T₂ is too high, W₂O₃ may be easily generated.

A calcination time in the second calcination step is, for example, 1 hour or longer and 5 hours or shorter, and may be 2 hours or longer and 4 hours or shorter. A calcination time in the second calcination step may be shorter than a calcination time in the first calcination step. An atmosphere in the second calcination step is usually an atmosphere in which oxygen is present. Examples of a calcination method in the second calcination step include a method of using a calcining furnace such as a muffle furnace and an electric furnace.

In the second calcination step, a pulverization process of pulverizing the second calcined product may be performed. Examples of a pulverization method in the pulverization process include a jet mill, a hammer mill, a lab mill, and a ball mill.

### 3. Positive Electrode Active Material

The positive electrode active material obtained by each of the above-described steps is the same as the content described in “A. Positive electrode active material” described above.

The present disclosure is not limited to the embodiment. The embodiment is an example and anything that has substantially the same configuration as the technical idea described in the claims of the present disclosure and produces the same effect is included in the technical scope of the present disclosure.

### Comparative Example 1

### Preparation of Positive Electrode Active Material

As a raw material, NiSO₄, CoSO₄, and MnSO₄ were prepared, and these were dissolved in ion exchange water to prepare a raw material aqueous solution. The proportion of Ni, Co, and Mn in the raw material aqueous solution was set to Ni:Co:Mn=8:1:1 in terms of a molar ratio. In addition, a concentration of the raw material aqueous solution (proportion of all raw materials to the raw material aqueous solution) was 30% by mass.

Thereafter, a certain amount of an aqueous ammonia solution was added to the reaction container, and the inside of the reaction container was replaced with nitrogen while stirring with a stirrer. An aqueous NaOH solution was added to the reaction container, the pH was maintained in an alkaline range (pH=12), and the raw material aqueous solution and the aqueous ammonia solution were added dropwise while controlling the temperature to a certain temperature, thereby precipitating a transition metal hydroxide. The reaction temperature was 60° C., and the reaction time was 3 hours. Next, the precipitated transition metal hydroxide was taken out by filtration, and washed with water by adding ion exchange water and dispersing with a spoon. The transition metal hydroxide after washing with water was dried under the conditions of 120° C. and 16 hours to obtain a transition metal hydroxide as a precursor.

Thereafter, a Li source (LiOH) was added to the obtained precursor, and mixed with an agate mortar to obtain a first mixture. An addition amount of the Li source was adjusted such that a molar ratio (Li/NCM) of Li contained in the Li source to the total of Ni, Co, and Mn contained in the precursor (NCM) was 1.1. The obtained first mixture was calcined in a calcining furnace under the conditions of 900° C., an oxygen atmosphere, and 10 hours to obtain a calcined product. The obtained calcined product was crushed using a jet mill to adjust the particle diameter, thereby obtaining a positive electrode active material.

### Preparation of Battery

A battery was prepared using the obtained positive electrode active material. Specifically, a positive electrode mixture paste containing a positive electrode active material, a conductive material (acetylene black), and a binder (polyvinylidene fluoride) at a mass ratio of positive electrode active material:conductive material:binder=88:10:2 was applied onto a surface of a metal foil, which was a positive electrode current collector, using a film applicator with a film thickness adjustment function (manufactured by Allgrid Co., Ltd.). Thereafter, the positive electrode was dried at 80° C. for 5 minutes in a dryer to obtain a positive electrode having a positive electrode current collector and a positive electrode active material layer.

Next, a negative electrode mixture paste containing a negative electrode active material (natural graphite) and a binder (SBR and CMC) was applied onto a surface of a metal foil, which was a negative electrode current collector, using a film applicator with a film thickness adjustment function (manufactured by Allgrid Co., Ltd.). Thereafter, the negative electrode was dried at 80° C. for 5 minutes in a dryer to obtain a negative electrode having a negative electrode current collector and a negative electrode active material layer. Next, as an electrolytic solution, a 1 M LiPF₆ solution was prepared. As a solvent of the electrolytic solution, a mixed solvent obtained by mixing ethylene carbonate (EC), dimethyl carbonate (DMC), and ethyl methyl carbonate (EMC) at a volume ratio of EC:DMC:EMC=3:4:3 was used. A wound cylindrical battery was obtained using the positive electrode, the negative electrode, and the electrolytic solution.

### Comparative Example 2

A precursor was obtained in the same manner as in Comparative Example 1. A Li source (LiOH), a La source (La(OH)₃), and a W source (H₂WO₄) were added to the obtained precursor, and mixed with an agate mortar to obtain a first mixture. An addition amount of the Li source was adjusted such that a molar ratio (Li/NCM) of Li contained in the Li source to the total of Ni, Co, and Mn contained in the precursor (NCM) was 1.1. In addition, an addition amount of the La source was adjusted such that La/NCM was 0.01, and an addition amount of the W source was adjusted such that W/NCM was 0.01. The obtained first mixture was calcined in a calcining furnace under the conditions of 900° C., an oxygen atmosphere, and 10 hours to obtain a calcined product. The obtained calcined product was crushed using a jet mill to adjust the particle diameter, thereby obtaining a positive electrode active material.

### Example 1

A precursor was obtained in the same manner as in Comparative Example 1. A Li source (LiOH) and a La source (La(OH)₃) were added to the obtained precursor, and mixed with an agate mortar to obtain a first mixture. An addition amount of the Li source was adjusted such that a molar ratio (Li/NCM) of Li contained in the Li source to the total of Ni, Co, and Mn contained in the precursor (NCM) was 1.1. In addition, an addition amount of the La source was adjusted such that La/NCM was 0.01. The obtained first mixture was calcined in a calcining furnace under the conditions of 900° C., an oxygen atmosphere, and 10 hours to obtain a first calcined product.

A W source (H₂WO₄), a Li source (LiOH), and an oxidizing agent (KMnO₄) were added to the obtained first calcined product, and mixed with an agate mortar to obtain a second mixture. An addition amount of the Li source was adjusted such that Li/NCM was 0.005, and an addition amount of the oxidizing agent was adjusted such that KMnO₄/NCM was 0.01. The obtained second mixture was calcined in a calcining furnace under the conditions of 600° C., an oxygen atmosphere, and 3 hours to obtain a second calcined product. The obtained second calcined product was crushed using a jet mill to adjust the particle diameter, thereby obtaining a positive electrode active material. A battery was obtained in the same manner as in Comparative Example 1, except that the obtained positive electrode active material was used.

### Example 2

A positive electrode active material and a battery were obtained in the same manner as in Example 1, except that an addition amount of the Li source in the second mixture was adjusted such that Li/NCM was 0.01.

### Example 3

A positive electrode active material and a battery were obtained in the same manner as in Example 1, except that an addition amount of the Li source in the second mixture was adjusted such that Li/NCM was 0.05.

### Evaluation

### SEM-EDX Measurement

For the positive electrode active materials obtained in Examples 1 to 3, a cross-sectional observation and an element analysis were performed by scanning electron microscope-energy dispersive X-ray spectroscopy (SEM-EDX). As a result, in Examples 1 to 3, a particle-shaped compound was confirmed on the surface of the primary particles, and from the mapping image, it was confirmed that the particle-shaped compound contained La, Ni, and O.

### TEM-EDX Measurement

For the positive electrode active materials obtained in Examples 1 to 3, a cross-sectional observation and an element analysis were performed by transmission electron microscope-energy dispersive X-ray spectroscopy (TEM-EDX). As a result, on the surface of the primary particles in Examples 1 to 3, a film-shaped compound (thickness of 20 nm or less) was confirmed, and from the mapping image, it was confirmed that the film-shaped compound contained W and O. Further, on the surface of the particle-shaped compound (compound A) present on the surface of the primary particles, the film-shaped compound (compound B, thickness of 20 nm or less) was confirmed, and the proportion of the compound B covering the surface of the compound A was 10% or more in all cases.

### TEM-EELS Measurement

For the positive electrode active materials obtained in Examples 1 to 3, the W intensity was measured by transmission electron microscope-electron energy loss spectroscopy (TEM-EELS). Specifically, as shown in FIG. 2, the W intensity was measured by EELS analysis from the surface of the compound B covering the compound A toward the center of the primary particles. As a result, first, a peak (peak intensity α) was detected, next, a constant intensity β was detected, and then, a constant intensity γ was detected, and it was confirmed that these were in a relationship of α>γ>β.

### Initial Resistance

The initial resistance was measured using the batteries obtained in Examples 1 to 3 and Comparative Examples 1 and 2. Specifically, the above-described battery was charged to 4.3 V, and then discharged to 3.7 V. Thereafter, the voltage drop (V) in a case of discharging for 10 seconds under the conditions of each C-rate of 0.1 C, 0.3 C, 0.5 C, 0.7 C, and 1.0 C at 25° C. was measured. A relationship between the voltage drop (V) and the current value was plotted, and a slope in a case where an approximate straight line was drawn by a linear function was defined as a resistance (IV resistance). Table 1 shows the result. It is noted that the value of the initial resistance in Table 1 is a relative value in a case where the initial resistance of Comparative Example 1 is 100%.

### Cycle Resistance Increase Rate

The cycle resistance increase rate was measured using the batteries obtained in Examples 1 to 3 and Comparative Examples 1 and 2. Specifically, the resistance (IV resistance) before and after the cycle test was measured. The cycle test was performed for 100 cycles under the conditions of a voltage range of 3.0 V to 4.3 V, a C-rate of 0.3 C, a mode of CC charging and discharging, and a temperature of 50° C., and the cycle resistance increase rate was determined based on the following expression.

Cycle resistance increase rate (%)=(Resistance after cycle test)/Initial resistance×100

Table 1 shows the result.

TABLE 1

| | | | | | | | | Cycle |
|---|---|---|---|---|---|---|---|---|
| | | | | | | | Initial | resistance |
| | Ratio | | | | | | resistance | increase |
| | Li | Ni | Co | Mn | La | W | (%) | rate (%) |
| Comparative | 1.1 | 0.8 | 0.1 | 0.1 | — | — | 100 | 154 |
| Example 1 | | | | | | | | |
| Comparative | 1.1 | 0.8 | 0.1 | 0.1 | 0.01 | 0.01 | 86 | 133 |
| Example 2 | | | | | | | | |
| Example 1 | 1.1 | 0.8 | 0.1 | 0.1 | 0.01 | 0.01 | 78 | 110 |
| Example 2 | 1.1 | 0.8 | 0.1 | 0.1 | 0.01 | 0.01 | 76 | 108 |
| Example 3 | 1.1 | 0.8 | 0.1 | 0.1 | 0.01 | 0.01 | 77 | 107 |

As shown in Table 1, it was confirmed that Examples 1 to 3 had a lower initial resistance than Comparative Example 1. This is because a compound A having favorable electron conductivity (compound A containing La, Ni, and O) and a compound B having favorable ion conductivity (compound B containing Li, W, and O) are present on the surface of the primary particles. It is presumed that this is because the movement of electrons and ions is smooth. In addition, it was confirmed that Examples 1 to 3 had a smaller cycle resistance increase rate than Comparative Example 2. It is presumed that this is because, by covering the surface of the compound A with the compound B, it is possible to suppress the accumulation of the resistance component (decomposition product) generated by the side reaction caused by electron conductivity on the surface of the compound A.

What is claimed is:

1. A positive electrode active material comprising primary particles that have crystallinity, the primary particles containing Li, a transition metal (TM), and O, wherein:
the positive electrode active material is a single crystal active material made of the primary particles;
a compound A containing La, Ni, and O and a compound B containing Li, W, and O are present on a surface of the primary particles;
the compound A has a particle shape;
the compound B has a film shape; and
the compound B covers the surface of the primary particles and covers a surface of the compound A.

2. The positive electrode active material according to claim 1, wherein, in a cross section of the positive electrode active material, a proportion of the compound B that covers the surface of the compound A is 10% or more.

3. The positive electrode active material according to claim 1, wherein, in a cross section of the positive electrode active material, a thickness of the compound B that covers the surface of the compound A is 20 nm or less.

4. The positive electrode active material according to claim 1, wherein:
in a case where a W intensity is measured by EELS analysis from a surface of the compound B that covers the compound A toward a center of the primary particles, first, a peak having a peak intensity α is detected, next, a constant intensity β is detected, and then, a constant intensity γ is detected; and
the peak intensity α, the constant intensity β, and the constant intensity γ satisfy a relationship of α>γ>β.

5. A battery comprising:
a positive electrode active material layer containing a positive electrode active material;
a negative electrode active material layer containing a negative electrode active material; and
an electrolyte layer disposed between the positive electrode active material layer and the negative electrode active material layer,
wherein the positive electrode active material layer contains the positive electrode active material according to claim 1.
